(19) United States
(12) Patent Application Publication
(10) Pub. No.: US 2010/0304089 A1
(43) Pub. Date: Dec. 2, 2010

(54) Manufactured Wood Boards Having a Distressed Appearance

(76) Inventor: Tryggvi Magnusson, Wausau, WI (US)

Correspondence Address: BOYLE FREDRICKSON S.C., 840 North Plankinton Avenue, MILWAUKEE, WI, 53203, US

(21) Appl. No.: 12/471,869

(22) Filed: May 26, 2009

(51) Int. Cl. B32B 3/10; B29C 59/02

(52) U.S. Cl. 428/158; 264/293

(57) ABSTRACT

The present invention is a wood-based product utilized in forming various structures and other items. The product includes a piece of wood disposed on the exposed surface of the product that has been embossed with a desired pattern to give the product a desired appearance, such as a distressed or weathered appearance. The wood piece used in the product is embossed at a sufficient temperature and pressure to create the desired appearance in the wood piece. Additionally the product can be formed completely or only partially from the wood piece.

### FIELD OF THE INVENTION

The present invention relates to wood boards and more specifically to boards formed of wood or at least partially of wood having a desired appearance that is manufactured into the wood portion of the board during its construction that is used for flooring, wall or ceiling panels.

### BACKGROUND OF THE INVENTION

When utilizing wood-based products to provide the desired aesthetic properties to a structure or item, there are many different choices to be made with regard the form, type and style of the wood-based products.

One choice that can greatly affect the structure or the item or structure is the appearance of the wood-based product. Specifically, many wood products are selected for particular uses based solely on the look or feel the wood can provide to the structure or item.

On many occasions, certain desired looks or appearances for these structures or items are provided by wood-based products that have a natural appearance, such as a weathered or distressed appearance for the wood. This look has historically been achieved by natural forces acting on the wood to provide the desired appearance, or by manually scraping or gouging the exposed surface of the wood. Due to the lengthy amount of time required for the wood to achieve the preferred appearance according to either of these methods, it is desirable to develop a method for providing product having this desired appearance.

To this end, certain types of products have been developed that are able to be formed with this desired appearance in a mechanical manner, greatly reducing the time required to produce these materials. However, these materials are formed of non-wood materials, such as paper, that is shaped into the desired appearance through a suitable molding process. These molded paper materials can be printed to illustrate the particular wood product they are designed to imitate, and then are molded in a manner that conforms to the images of the wood printed on the paper. Thus, in this manner it is possible to form a product that has the appearance of weathered or distressed wood, but that is not a wood product.

However, in certain situations it is desirable to have a wood-based product that is able to provide the particular desired appearance and other attributes of natural wood, without the need for expending the amount of time and/or effort necessary to create the desired appearance for the wood-based product.

Therefore, it is desirable to develop a process for creating a wood-based product and a product formed by the process that can be provided with an appearance simulating a naturally induced appearance, e.g., a distressed or weathered appearance, for the product.

### SUMMARY OF THE INVENTION

According to one aspect of the present invention, a wood-based product is provided that is formed at least partially of natural wood to give the product the desired wood-like appearance with or with out chisel marks. To give the product a natural looking appearance in addition to the appearance of the wood itself, and in particular a weathered or distressed appearance, the product is embossed to give the natural wood component of the product the desired appearance. To emboss the wood component, the wood component is compressed at a sufficient temperature and pressure to enable the wood component to be deformed and/or shaped in the desired manner.

According to another aspect of the present invention, the wood component can form the entire wood-based product, or can take the form of a veneer layer disposed over other wood-based or non-wood-based layers, such as in an engineered wood board product.

Numerous other aspects, features and advantages of the present invention will be made apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is a perspective view of a first embodiment of a wood-based product formed according to the present invention;

FIG. 2 is a cross-sectional view along line 2-2 of FIG. 1;

FIG. 3 is a perspective view of a second embodiment of a wood-based product formed according to the present invention;

FIG. 4 is a cross-sectional view along line 4-4 of FIG. 3;

FIG. 5 is a perspective view of a third embodiment of a wood-based product formed according to the present invention;

FIG. 6 is a cross-sectional view along line 6-6 of FIG. 5; and

FIG. 7 is a perspective view of an embossing machine utilized in the manufacture of the product of FIG. 1.

### DETAILED DESCRIPTION OF THE INVENTION

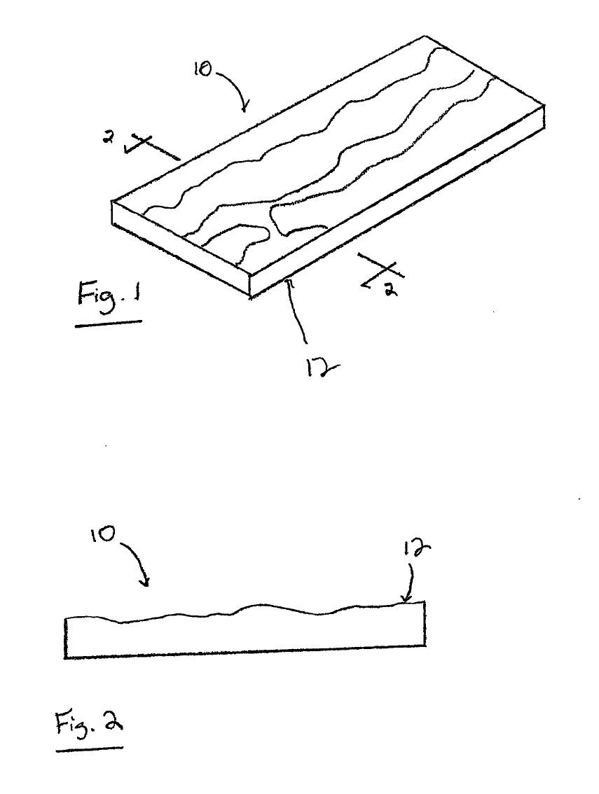

With reference now to the drawing figures in which like reference numerals designate like parts throughout the disclosure, a first embodiment of a wood product constructed according to the present invention is illustrated in FIG. 1 generally at 10. The wood product 10 is formed of a unitary piece or board 12 of North American hardwoods, such as red oak, white oak, hard maple, red maple, birch, beech, walnut, ash, cherry, alder, elm, hickory, pecan, hackberry, Brazilian cherry, Brazilian walnut, Bolivian cherry, Brazilian teak, Santos mahogany, African rosewood, Merbau, African padeuk, kempas, zebra wood, tiger wood, wenge, Australian cypress, teak, and eucalyptus, among others. The board 12 can have virtually any desired thickness depending upon the particular use to which the board is to be put, but preferably has a thickness of between about 0.6 mm to about 20 mm. Preferably, the board 12 has a thickness in the range of about 1 mm to about 25.4 mm, with a particularly preferred thickness of around 10 mm in its final product form.

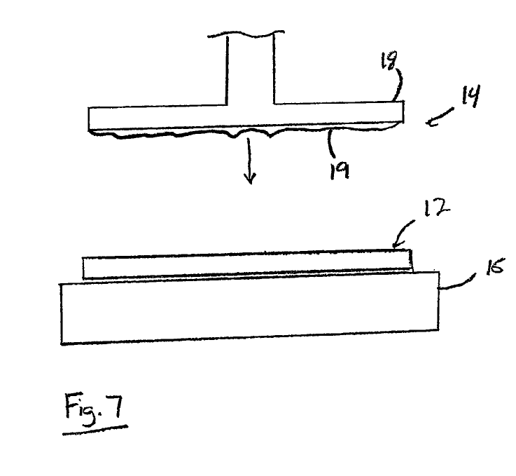

Once the board 12 is selected based on the type of wood forming the board 12 and the thickness of the board 12, the board 12 is positioned within an embossing device 14 shown in FIG. 7 that includes a support member 16 to hold the board 12, and an embossing member 18 located opposite the support member 16. One or both of the support member 16 and the embossing member 18 are movable with regard to one another, such that the support member 16 and the embossing member 18 can be brought towards one another. Also, the embossing member 18 can be formed to have the desired surface for the board 12 disposed directly on the surface 19 of the member 18 that engages the board 12, or the surface 19 can be used to secure a separate embossing structure (not shown) to the embossing member 18 on which the desired surface is disposed that is to be used to engage and deform the board 12.

To assist in embossing the board 12, the board 12 is heated to a desired temperature below a combustion point for the board 12, but above a temperature at which the structure of the board 12 is affected such that the board 12 becomes more easily deformed. In one embodiment, the heating of the board 12 can be done by preheating the board 12 in any suitable manner prior to introducing the board 12 into the device 14. Additionally or as an alternative to the preheating of the board 12, at least one or both of the embossing member 18 and support member 16 can be heated to consequently heat the board 12 to a desired temperature where the board 12 becomes more easily deformed. Preferably both the support member 16 and the embossing member 18 are heated to increase the speed of heating of the board 12 and the overall speed of the embossing process.

Regardless of how the board 12 is heated, the temperature that the board 12 is heated to is preferably ≧100° C., and more preferably ≧150° C. At these temperatures, the material forming the board 12 softens to the point that it can be more easily deformed in the device 14 as desired.

Once the board 12 has been heated to the desired temperature, the support member 16 and the embossing member 18 are moved towards each other, such that the board 12 is brought into contact with the embossing member 18. The embossing member 18 is formed with a pattern on it that represents the desired appearance for the exposed surface of the board 12. The pattern can have any desired configuration, such that the pattern can be selected to provide any desired appearance for the exposed surface of the board 12. This pattern is pressed into the heated board 12 to deform the exposed surface of the board 12 such that the exposed surface is impressed with the pattern on the embossing member 18. To ensure that the pattern from the embossing member 18 is effectively and permanently impressed into the board 12, the embossing member 18 is pressed into the board 12 at a sufficient pressure to permanently deform the exposed surface of the board 12 into the desired pattern, as best shown in FIG. 2. Preferably, the pressure at which the embossing member 18 is pressed into the board 12 is between 300 psi and 800 psi. At these pressures, the pattern on the embossing member 18 is permanently formed in the board 12 without damaging the board 12, thereby providing a board 12 having the desired appearance that is also structurally sound such that it is able to be used in the intended manner.

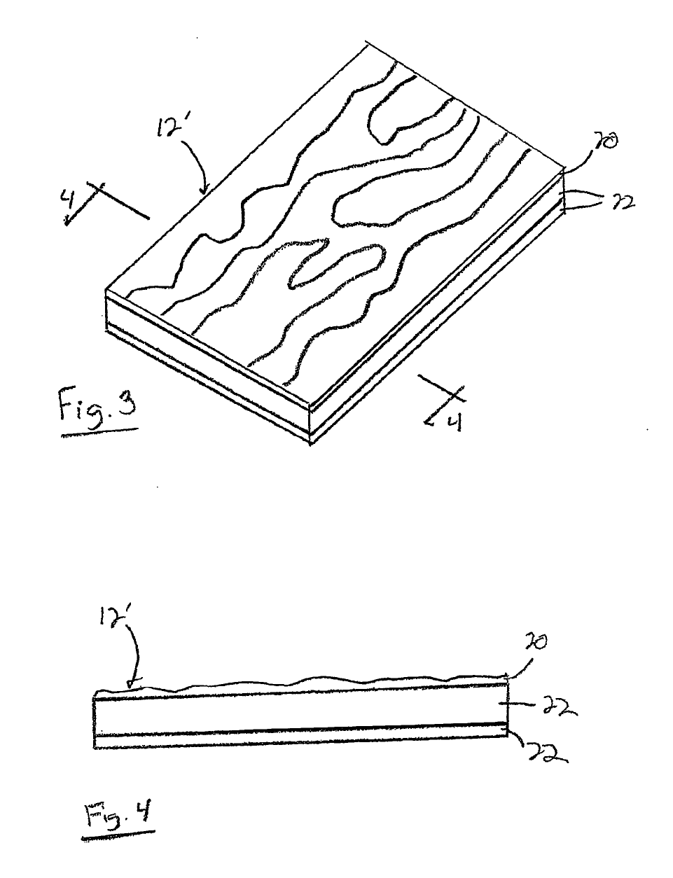

Looking now at FIGS. 3 and 4, another embodiment of the product 10 is illustrated in which the board 12′ is an engineered board formed of a veneer layer 20 formed from a selected wood having the desired appearance, and a number of core layers 22 over which the veneer layer 20 is placed. The board 12′ can have the same overall thickness as the board 12, such that it can be utilized in the same manner for the same purposes, with the veneer layer 20 having a thickness of between about 0.60 mm to about 6.00 mm, with the remainder of the thickness of the board 12′ being made up by the core layers 22. This thickness for the veneer layer 20 is fairly important as it provides sufficient rigidity to the board 12 while also being thin enough for the layer 20 to readily accept the pattern from the embossing member 18.

The core layers 22 can be formed of any suitable material, such as a resin material or wood-based composite material, such as HDF, and are attached to the veneer layer 20 in any suitable manner. In one embodiment, the core 22 is formed of multiple layers of these materials, which can be secured to one another in any suitable manner, such as by using mechanical fasteners or a suitable adhesive, among others, and can be formed of the same material or mixed material layers. The core 22 formed of these layers is preferably formed to have a thickness of about 4 mm to about 20 mm.

Alternatively, the core 22 can be formed as a single piece of a desired material, such as HDF, with a thickness of between about 4 mm to about 20 mm.

In the embodiment shown in FIGS. 3 and 4, the board 12′ is positioned within the device 14 and embossed in a manner similar to that utilized for the board 12. However, due to the thickness of the veneer 20, the temperature and pressure at which the board 12′ is embossed can optionally be altered from that used on the board 12 if the veneer layer 20 is more receptive to having the pattern on the embossing member 18 impressed on it due to its reduced thickness.

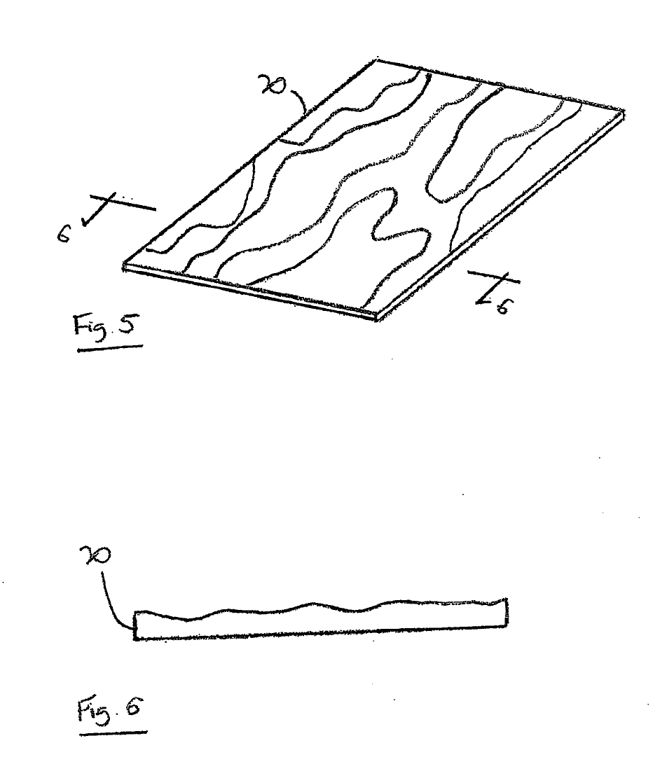

Referring now to FIGS. 5 and 6, in a third embodiment, the veneer 20 can inserted into the device 14 and embossed with the pattern on the embossing member 18 by itself, such that the veneer layer 20 can later be secured to one or more suitable core layers 22 to form an engineered board 12′.

Various alternatives are contemplated as being within the scope of the following claims particularly pointing out and distinctly claiming the subject matter regarded as the invention.

What is claimed is:

1. A wood-based product formed by a process comprising the steps of:
a) placing a piece of wood in a forming device; and
b) embossing a desired pattern on the piece of wood.

2. The product of claim 1 further comprising the step of attaching the piece of wood to a suitable core member prior to placing the piece of wood in the forming device.

3. The product of claim 2 wherein the step of attaching the piece of wood to a suitable core member comprises attaching the piece of wood to multiple core members.

4. The product of claim 3 wherein the core members are selected from one or more of the group consisting of: a resin material or wood-based composite material.

5. The product of claim 4 wherein the core members are formed from HDF.

6. The product of claim 1 wherein the step of embossing the piece of wood comprises embossing the piece of wood at a pressure in excess of 300 psi.

7. The product of claim 6 wherein the step of embossing the piece of wood comprises embossing the piece of wood at a pressure of between 300 psi and 800 psi.

8. The product of claim 1 wherein the step of embossing the piece of wood comprises embossing the piece of wood at a temperature in excess of 100° C.

9. The product of claim 8 wherein the step of embossing the piece of wood comprises embossing the piece of wood at a temperature in excess of 150° C.

10. The product of claim 2 wherein the wood has a thickness of between about 0.60 mm to about 6.00 mm.

11. A method for forming a decorative wood piece, the method comprising the steps of:
a) providing a wood piece formed of a suitable material;
b) placing a piece of wood in a forming device including a heated embossing member; and
c) embossing a desired pattern on the piece of wood.

12. The method of claim 11 wherein the step of embossing the piece of wood comprises heating the embossing member to a temperature in excess of 100° C.

13. The method of claim 11 wherein the step of embossing the piece of wood comprises engaging the embossing member with the piece of wood at a pressure of between 300 psi and 800 psi.

14. The method of claim 11 wherein the step of providing the piece of wood comprises providing a veneer sheet of wood having a thickness of between about 0.60 mm to about 6.00 mm.

15. The method of claim 11 wherein the step of providing the piece of wood comprises providing a piece of wood having a thickness in the range of about 0.60 mm to about 25.4 mm.
